(19) United States
(12) Patent Application Publication
(10) Pub. No.: US 2016/0071078 A1
(43) Pub. Date: Mar. 10, 2016

(54) Internet Access Kiosk and Related System

(71) Applicant: Antonio Corona, Torrance, CA (US)

(72) Inventor: Antonio Corona, Torrance, CA (US)

(21) Appl. No.: 14/849,575

(22) Filed: Sep. 9, 2015

Related U.S. Application Data
(60) Provisional application No. 62/048,189, filed on Sep. 9, 2014.

(51) Int. Cl. G06Q 20/18

(52) U.S. Cl. CPC G06Q 20/18

(57) ABSTRACT

An Internet access kiosk and related system provides internet service in public locations. The kiosk preferably corresponding to the position of the user when using the kiosk: sitting in a comfortable reclining chair, standing on a sidewalk, or seated on a barstool. A per-minute fee is charged for use of the kiosk, and is secured with a credit or debit card, or deposit of currency, using a card reader or currency slot which is provided. When payment of the fee is secured, the kiosk instantly provides access to the Internet on a high-quality full-size computer with high-speed Internet service. The kiosk provides a Universal Service Bus (USB) port and upon completion of the Internet session, the kiosk offers the option of saving any work performed on a flash drive which may be provided by the user, or obtained from a vending machine which may also be provided.

### CROSS-REFERENCE TO RELATED APPLICATIONS

This Application claims the benefit of U.S. Provisional Application No. 61/934906, filed Feb. 03, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to public access vending and service machines and in particular to an Internet access kiosk and related system. The public access pay phone booth, a routine feature at urban street corners for nearly 100 years, has virtually disappeared due to the ubiquitous cellular telephone. However, one type of communications need is frequently unsatisfied for people who are not at home or at the office. Many cellular telephones still do not have Internet capability, and it is far more common for such a device to provide Internet capability that is difficult to use, unable to obtain an adequate signal, or inadequate in any one of many other ways. Most smartphone users still prefer to use a full-size computer and keyboard when accessing the Internet, and such a service is frequently unavailable. When such services are available, simply getting online and gaining access to one's daily email inbox can take several minutes. An Internet access kiosk and related system, which provides use of a full-size computer for a per-minute fee in a variety of public settings and embodiments, and enables immediate access to the Internet by the user the moment payment of the fee is secured, would resolve this problem. Such a system may be understood as a vending machine for Internet access.

### SUMMARY OF THE INVENTION

Accordingly, the invention is directed to an Internet access kiosk and related system. The kiosk is preferably provided in three embodiments, corresponding to the position of the user when using the kiosk: sitting in a comfortable reclining chair, standing on a sidewalk, or seated on a barstool. A per-minute fee is charged for use of the kiosk, and is secured with a credit or debit card, or deposit of currency, using a card reader or currency slot which is provided. When payment of the fee is secured, the kiosk instantly provides access to the Internet on a high-quality full-size computer with high-speed Internet service. The kiosk provides a Universal Service Bus (USB) port and upon completion of the Internet session, the kiosk offers the option of saving any work performed on a flash drive which may be provided by the user, or obtained from a vending machine which may also be provided.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

FIG. 1 is a front view of the first exemplary embodiment, displaying the chair 10, the armrests 10A, the visual display 11, and the arm 11A.

FIG. 2 is a side view of the first exemplary embodiment, displaying the chair 10, the armrests 10A, the visual display 11, the arm 11A, and the vending panel 12.

FIG. 3 is a front view of the second exemplary embodiment, displaying the visual display 11, the keyboard 11B, and the vending panel 12.

FIG. 4 is a front perspective view of four examples of the third exemplary embodiment provided on a bar with barstools, displaying the modules 10B, and the visual displays 11.

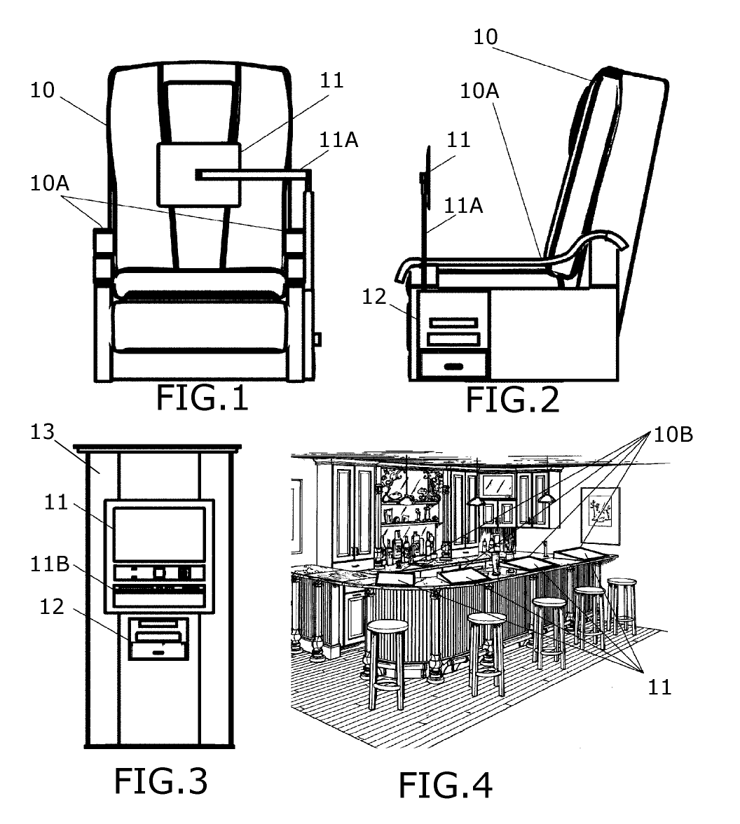

### DETAILED DESCRIPTION OF THE INVENTION

Referring now to the invention in more detail, the invention is directed to an Internet access kiosk and related system.

The kiosk is preferably provided in three embodiments, corresponding to the position of the user when using the kiosk: sitting in a comfortable reclining chair, standing on a sidewalk, or seated on a barstool. Alternate embodiments, wherein other arrangements may be provided for the user to sit or stand, are contemplated. It is to be understood that while each of the three exemplary embodiments is intended for use in a certain range of locations, this is not intended as a limitation. With suitable modifications, the invention may be used in virtually any public location which experiences substantial foot traffic.

The first exemplary embodiment provides a flat-screen visual display 11, preferably with touchscreen capability, mounted on a swiveling arm 11A on a comfortable reclining chair 10. The first exemplary embodiment is intended for use in such locations as hotel lobbies, airport terminals, libraries, bookstores, coffee shops, and other indoor hosting venues. A per-minute fee is charged for use of the kiosk, and is secured with a credit or debit card, or deposit of currency, using a card reader or currency slot which is provided on a vending panel 12. The vending panel 12 is preferably located on the side of the chair 10, below one of the armrests 10A. The visual display 11 is connected to a high-quality full-size computer with high-speed Internet service, located within the chair 10 beneath the seat.

When payment of the fee is secured, the visual display 11 instantly provides access to the Internet on the computer. An internal compartment may be provided within one of the armrests 10A, wherein a keyboard may be provided. The keyboard may be wireless, or connected to the computer via a cable. The keyboard may provide a trackball or touchpad, or the armrests 10A may provide mousepads with a wired or wireless mouse, preferably for use by both left-handed and right-handed users. The keyboard may be provided on a fold-away platform, or it may be capable of being held on the user's lap while seated in the chair 10.

If the visual display 11 provides touchscreen capability, it may be used as a tablet. The arm 11A is sturdy, easily adjustable, and locks into any desired position, such that the user may clearly view the visual display 11 and use it at a comfortable distance when seated in an upright or reclined position.

Preferably, the visual display 11 provides a Universal Service Bus (USB) port. Upon completion of the Internet session, the kiosk offers the option of saving any work performed on a flash drive which may be provided by the user, or obtained from a vending machine which may also be provided at a nearby location, within the same establishment. Laser printing of documents may also be provided for a separate fee, dispensing the printed documents into a retractable tray beneath the vending panel 12.

The second exemplary embodiment is structurally and functionally similar to the first exemplary embodiment, with the following modifications. It is intended to be used while the user is standing, providing components which are arranged in a frame 13 which is structured in a manner similar to an automatic teller machine (ATM), and is intended for use and installation in such locations as the exterior wall of a building at sidewalk level, the lobby of a bank or office building, a bus stop, a train station, a gas station, a shopping mall, or similar venues indoors or outdoors.

Preferably, the visual display 11 and the computer are mounted within a wall, with a folding keyboard 11B below the visual display 11, and the vending panel 12 below the keyboard 11B. No arm 11A or chair 10 is provided. Preferably, the keyboard 11B automatically folds and locks in the folded position when not in use, and may be unfolded when the fee is secured with the vending panel 12. The keyboard 11B preferably provides a trackball, a touchpad, or a mousepad with a wired mouse.

The third exemplary embodiment is structurally and functionally similar to the first exemplary embodiment, with the following modifications. It is intended to be used while the user is standing or seated on a barstool, providing components which are arranged in a manner similar to the gaming tablets provided in many video poker bars, and is intended for installation and use in video poker bars, lunch counters, and similar indoor establishments.

Preferably, the visual display 11 and the computer are mounted within a module 10B which gently inclines the visual display 11 on its top surface toward the user, and is intended for placement on a bar, countertop, or similar surface. The vending panel 12 is preferably located on the side of the module 10B. A keyboard is preferably provided in a sliding drawer on the front surface of the module 10B. Preferably, the drawer automatically slides inward and locks in the closed position when not in use, and may be opened when the fee is secured with the vending panel 12. The keyboard preferably provides a trackball, a touchpad, or a mousepad with a wired mouse.

For all exemplary embodiments, basic Internet user services are provided and available instantly when the per-minute fee is secured with the vending panel 12. Such services preferably include at least one type of Internet browser, online games, and game applications. The system is operated by an application which provides instructions for the user, and a full description of the fee structure for the available services, on the visual display 11. The system preferably gains Internet access via a modem and wireless router provided by the hosting establishment.

To use the first, second, and third exemplary embodiments, the user inserts a credit or debit card or currency into the corresponding slots on the vending panel 12. The application reads the card or the currency which has been inserted, then conducts a validity check on the card if applicable, and informs the user via the visual display 11 of the amount of time which is available, based on the available balance of the card or the amount of currency deposited. The system may also provide laser printing for an additional fee per page, to be deducted from the card or currency deposit. When the user's funds have been exhausted or the user elects to terminate the Internet session, the application prompts the user via the visual display 11 to print any documents prepared or save them on a flashdrive, using the USB port which is provided.

Electronic components of the system preferably include a touchscreen visual display 11, a keyboard 11B, a microprocessor, a memory device, a motherboard, a video driver, a power supply, a USB port provided in the visual display 11, a credit card reader and currency reader provided in the vending panel 12, and optionally a trackball, a touchpad, a wired or wireless mouse, and a printer. The system is preferably powered by standard household current, and provides a power cord which may be plugged into any standard three-pronged wall outlet.

The chair 10 is preferably manufactured from rigid, durable materials such as wood, steel, spring steel, and aluminum alloy, providing padding which is preferably manufactured from a flexible, durable material such as foam rubber, and covered by upholstery which is preferably manufactured from a flexible, durable material such as leather or wool fabric. The visual display 11 is preferably manufactured from a rigid, durable material which is transparent, such as malacrylate. The arm 11A is preferably manufactured from rigid, durable materials with substantial structural strength, such as steel and aluminum alloy. The module 10B, the keyboard 11B, the vending panel 12, and the electronic components are preferably manufactured from rigid, durable materials such as steel, aluminum alloy, brass, and plastic. The power cord is preferably manufactured from braided copper alloy wire sheathed in plastic.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An internet access kiosk, comprising:
(a) a flat screen digital display;
(b) a swivel arm;
(c) a chair;
(d) said flat screen digital display being mounted to one end of said swivel arm;
(e) said swivel arm being mounted to said chair on another end opposite said flat screen digital display;
(f) a vending panel;
(g) said vending panel having a card reader and currency slot;
(h) said vending panel being configured to accept payment via said card reader and said currency slot;
(i) a computer;
(j) said computer having internet access and being in electronic communication with said flat screen digital display;
(k) said computer and said flat screen digital display being configured to activate after a card has been read by said card reader or currency has been input into said currency slot.

2. The internet access kiosk of claim 1, wherein said flat screen digital display is a touchscreen digital display.

3. The internet access kiosk of claim 1, wherein said chair has arm rests; said vending panel being located on a side of said chair below said arm rest.

4. The internet access kiosk of claim 3, further comprising a keyboard; a mouse; an internal compartment within said armrest; said keyboard and said mouse being stored within said internal compartment.

5. The internet access kiosk of claim 1, wherein said flat screen digital display further comprises a universal serial bus port; said universal serial bus port being configured to transfer data to said computer.

6. The internet access kiosk of claim 1, wherein said vending panel further comprises a printing tray; a printer; said printer being in electronic communication with said computer; said printer and said computer being configured to print documents.

7. An internet access kiosk, comprising:
(a) a flat screen digital display;
(b) a frame;
(c) said flat screen digital display being mounted within said frame;
(d) a keyboard;
(e) said keyboard being mounted within said frame and being configured to fold into said frame;
(f) a vending panel;
(g) said vending panel having a card reader and currency slot;
(h) said vending panel being configured to accept payment via said card reader and said currency slot;
(i) a computer;
(j) said computer having internet access and being in electronic communication with said flat screen digital display and said keyboard;
(k) said computer, said flat screen digital display, and said keyboard being configured to activate after a card has been read by said card reader or currency has been input into said currency slot.

8. The internet access kiosk of claim 7, wherein said flat screen digital display is a touchscreen digital display.

9. The internet access kiosk of claim 7, wherein said keyboard includes one of: a trackpad, a trackball, a touchpad, or a mouse and mouse pad.

10. The internet access kiosk of claim 7, wherein said keyboard automatically unfolds from said fram after a card has been read by said card reader or currency has been input into said currency slot.

11. The internet access kiosk of claim 7, wherein said flat screen digital display further comprises a universal serial bus port; said universal serial bus port being configured to transfer data to said computer.

12. The internet access kiosk of claim 7, wherein said vending panel further comprises a printing tray; a printer; said printer being in electronic communication with said computer; said printer and said computer being configured to print documents.

13. An internet access kiosk, comprising:
(a) a flat screen digital display;
(b) a module;
(c) said flat screen digital display being mounted within said module;
(d) a vending panel;
(e) said vending panel being mounted within said module;
(f) said vending panel having a card reader and currency slot;
(g) said vending panel being configured to accept payment via said card reader and said currency slot;
(h) a computer;
(i) said computer having internet access and being in electronic communication with said flat screen digital display;
(j) said computer and said flat screen digital display being configured to activate after a card has been read by said card reader or currency has been input into said currency slot;
(k) a keyboard;
(1) said keyboard being in electronic communication with said computer.

14. The internet access kiosk of claim 13, wherein said flat screen digital display is a touchscreen digital display.

15. The internet access kiosk of claim 13, further comprising a drawer; said drawer being located on a front surface of said module; said drawer containing said keyboard; said drawer being configured to open after a card has been read by said card reader or currency has been input into said currency slot.

16. The internet access kiosk of claim 13, wherein said keyboard includes one of: a trackpad, a trackball, a touchpad, or a mouse and mouse pad.

17. The internet access kiosk of claim 13, wherein said flat screen digital display further comprises a universal serial bus port; said universal serial bus port being configured to transfer data to said computer.

18. The internet access kiosk of claim 13, wherein said vending panel further comprises a printing tray; a printer; said printer being in electronic communication with said computer; said printer and said computer being configured to print documents.
